(19) United States
(12) Patent Application Publication
(10) Pub. No.: US 2022/0101126 A1
(43) Pub. Date: Mar. 31, 2022

(54) APPLYING DIRECTIONALITY TO AUDIO

(71) Applicant: Hewlett-Packard Development Company, L.P., Spring, TX (US)

(72) Inventor: Sunil Bharitkar, Palo Alto, CA (US)

(73) Assignee: Hewlett-Packard Development Company, L.P., Spring, TX (US)

(21) Appl. No.: 17/426,678

(22) PCT Filed: Feb. 14, 2019
(86) PCT No.: PCT/US2019/017987

§ 371 Date: Jul. 29, 2021

(51) Int. Cl. G06N 3/08; G06N 3/04; H04S 7/00; G10L 19/008; A63F 13/54

(52) U.S. Cl. CPC G06N 3/08; G06N 3/04; H04S 7/303; A63F 2300/8082; A63F 13/54; H04S 2420/01; A63F 2300/6081; G10L 19/008

(57) ABSTRACT

The present disclosure describes techniques for adding a perception of directionality to audio. The method includes receiving a set of head related transfer functions (HRTFs). The method also includes training an artificial neural network based on the HRTFs to generate a trained artificial neural network, wherein the trained artificial neural network represents a subspace reconstruction model for generating interpolated HRTFs. The trained artificial neural network is generated using Bayesian optimization to determine a number of layers and a number of neurons per layer of the trained artificial neural network. The method also includes storing the trained artificial neural network, wherein the trained artificial neural network is used to reconstruct a new head related transfer function for a specified direction. The new head related transfer function is used to process an audio signal to produce a perception of directionality.

### BACKGROUND

Humans use their ears to detect the direction of sounds. Among other factors, humans use the delay between the two sounds and the shadowing of the head against sounds originating from the other side to determine the direction of sounds. The ability to rapidly and intuitively localize the origination of sounds helps people with a variety every day activities, as we can monitor our surroundings for hazards (like traffic) even when we can't see the direction they are coming from.

### DESCRIPTION OF THE DRAWINGS

Certain examples are described in the following detailed description and in reference to the drawings, in which:

FIG. 1 is a block diagram of an example system for adding directionality to audio;

FIG. 2 is a process flow diagram showing an example process for generating HRTF reconstruction models;

FIG. 3 is a process flow diagram showing an example process for adding directionality to sound using the HRTF reconstruction models generated as described in relation to FIG. 2;

FIG. 4 is a process flow diagram summarizing a method of generating a set of HRTF reconstruction models;

FIG. 5 is a process flow diagram summarizing a method of adding directionality to audio using the HRTF reconstruction models of FIG. 4; and

FIG. 6 is a block diagram showing a medium that contains logic for rendering audio to generate a perception of directionality.

### DETAILED DESCRIPTION

This disclosure describes techniques for adding directionality to audio signals. The audio signals received by the two ears can be modeled using Head-Related Transfer Functions (HRTFs). A hearing transfer function translates a noise originating at a given lateral angle and elevation (positive or negative) into two signals captured at either ear of the listener. In practice, HRTFs exist as a pair of impulse (or frequency) responses corresponding to a lateral angle, an elevation angle, and a frequency of the sound.

The HRTF data sets may be measured using a fixed noise for the input signal. In some examples, this input is a beep, a click, a white noise pulse, and/or another type of consistent noise, or a log-sweep. The data sets may be generated in an anechoic chamber using a dummy with microphones at the ear position. A number of such data sets are publically available, including: the IRCAM (Institute for Research and Coordination in Acoustics and Music) Listen HRTF dataset, the MIT (Massachusetts Institute of Technology) KEMAR (Knowles Electronics Manikin for Acoustic Research) dataset, the UC Davis CIPIC (Center for Image Processing and Integrated Computing) dataset, etc.

The measured HRTFs can be used to process audio signals to create the perception that a sound is emanating from a particular distance and/or direction relative to the listener. Providing a perception of direction to an audio signal may increase the usefulness of a number of technologies, including video games, virtual reality headsets, and others. This specification describes an approach where much of the processing may be performed in advance allowing speech and/or other audio signals to be directionalized without undue delay.

Additionally, the measured HRTF data sets are sparse, meaning they have data at intervals larger than the resolution of the average person. For example, the IRCAM Listen HRTF dataset is spatially sampled at 15 degree intervals. To provide a more realistic sound environment, the present disclosure describes techniques for generating interpolated HRTFs. The generation of the interpolated HRTFs may be accomplished through the use of trained artificial neural networks. For example, a stacked autoencoder and artificial neural network are trained using the HRTFs as an input. The result is an artificial neural network and decoder that can reconstruct HRTFs for arbitrary angles, for example, every 1 degree. The stacked autoencoder and the artificial neural network hyperparameters (e.g., number of layers, number of neurons per layer) are both optimized using Bayesian optimization to determine the optimum choice for the number of layers and the number of neurons per layer. This optimized network is designed to reduce the compute requirements for real-time processing time without sacrificing on the accuracy of the HRTF reconstruction.

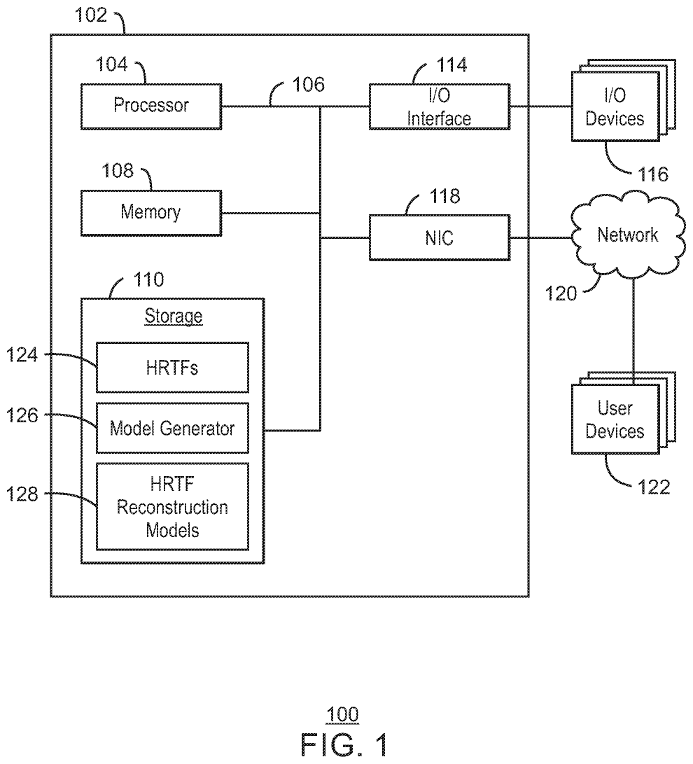

FIG. 1 is a block diagram of an example system for adding directionality to audio. The system 100 includes a computing device 102. The computing device 102 can be any suitable computing device, including a desktop computer, laptop computer, a server, and the like. The computing device 102 includes at least one processor 104. The processor 104 can be a single core processor, a multicore processor, a processor cluster, and the like. The processor 104 can be coupled to other units through a bus 106. The bus 106 can include peripheral component interconnect (PCI) or peripheral component interconnect express (PCIe) interconnects, Peripheral Component Interconnect eXtended (PCIx), or any number of other suitable technologies for transmitting information.

The computing device 102 can be linked through the bus 106 to a system memory 108. The system memory 108 can include random access memory (RAM), including volatile memory such as static random-access memory (SRAM) and dynamic random-access memory (DRAM). The system memory 108 can also include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. In an example, a memory can be used to implement persistent memory if it can be directly addressed by the processor at a byte or word granularity and has non-volatile properties.

The computing device 102 can include a tangible, non-transitory, computer-readable storage media, such as a storage device 110 for the long-term storage of data, including the operating system programs, software applications, and user data. The storage device 110 can include hard disks, solid state memory, or other non-volatile storage elements.

The processor 104 may be coupled through the bus 106 to an input output (I/O) interface 114. The I/O interface 114 may be coupled to any suitable type of I/O devices 116, including input devices, such as a mouse, touch screen, keyboard, display, and the like. The I/O devices 116 may also be output devices such as a display monitors.

The computing device 102 can also include a network interface controller (NIC) 118, for connecting the computing device 102 to a network 120. In some examples, the network 120 can be an enterprise server network, a storage area network (SAN), a local area network (LAN), a wide-area network (WAN), or the Internet, for example. In some examples, the network 120 is coupled to one or more user device 122, enabling the computing device 102 to store data to the user devices 122.

The storage device 110 stores data and software used to generate models for adding directionality to an audio signal, including the HRTFs 124, and the model generator 126. The HRTFs may be the measured HRTFs described above, such as the IRCAM Listen HRTF dataset, the MIT KEMAR dataset, the UC Davis CIPIC dataset, and others. The HRTFs may also be proprietary datasets. In some examples, the HRTFs may be sampled at increments of 15 degrees. However, it will be appreciated that other sampling increments are also possible, including 5 degrees, 10 degrees, 20 degrees, 30 degrees and others. Additionally, the HRTFs can include one set representing the left ear and a second set representing the right ear.

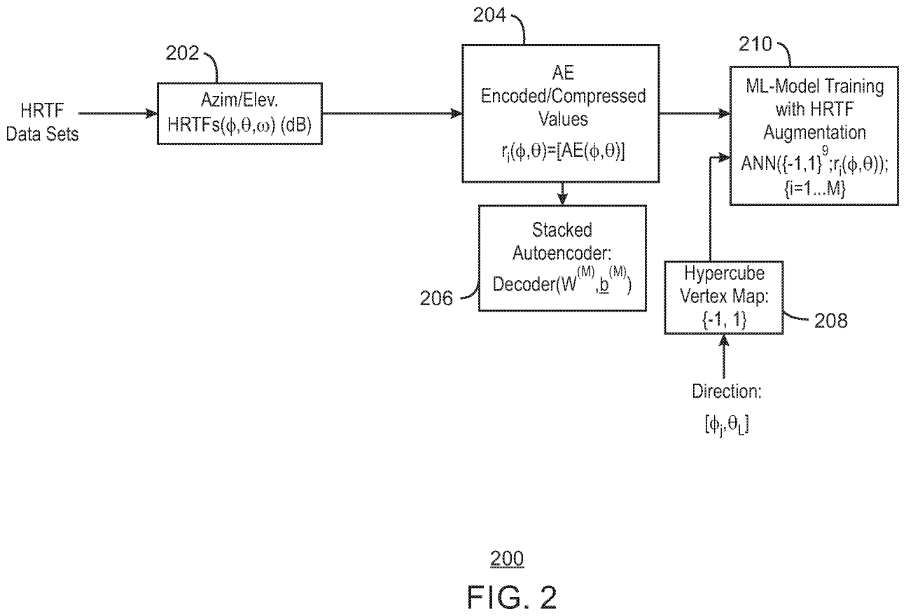

The model generator 126, using the HRTFs 124 as input, generates a model that can be used to add directionality to sound. For example, as described further below in relation to FIG. 2, the model generator 126 may create an autoencoder that generates a compressed representation of the input HRTFs. The autoencoder can be separated into an encoder portion and a decoder portion. The deepest layer of the encoder portion may be used to train an artificial neural network that enables reconstruction of new HRTFs at arbitrary angles. The model generator 126 may generate a first autoencoder and first artificial neural network for the left ear and a second autoencoder and second artificial neural network for the left ear.

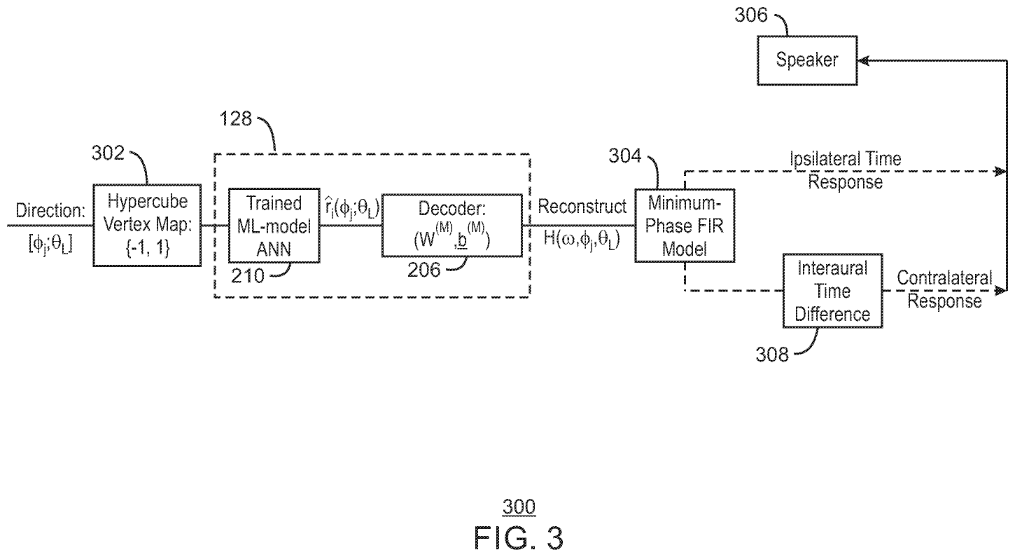

The artificial neural networks and the decoder portions of the autoencoders are referred to in FIG. 1 as HRTF reconstruction models 128. The HRTF reconstruction models 128 may be stored and copied to any number of user devices 122, such as gaming systems, virtual reality headsets, media players, and any other type of device capable of rendering audio to the two ears separately. The HRTF reconstruction models 128 can be used to add directionality to an audio signal rendered by the user device 122, as further described in relation to FIG. 3.

It is to be understood that the block diagram of FIG. 1 is not intended to indicate that the computing device 102 is to include all of the components shown in FIG. 1. Rather, the computing device 102 can include fewer or additional components not illustrated in FIG. 1. For example, the computing device 102 can include additional processors, memory controller devices, network interfaces, software applications, etc.

FIG. 2 is a process flow diagram 200 showing an example process for generating HRTF reconstruction models. The process shown in FIG. 2 may be performed by the computer system 102 shown in FIG. 1. For the sake of simplicity, the following description of the process 200 only describes the processing performed for a single ear. It will be appreciated that the process will be performed separately for both the left and the right ear.

The process starts with receiving an HRTF dataset, including both horizontal and elevation HRTFs as shown at block 202. Separate HRTF data sets will be used for the right-ear process and the left-ear process. The HRTFs are parameterized according to the corresponding azimuth, φ, elevation angle, θ, and frequency, ω. If the HRTFs are time-domain responses, the HRTFs are first converted to frequency responses. In some examples, the magnitude of each HRTF is a log magnitude corresponding to 1024 frequency bin values for each of the left-ear and right-ear responses. This HRTF data is used to train an unsupervised autoencoder. An autoencoder is a type of artificial neural network that is trained to replicate its input at its output. The training process is based on the optimization of a cost function, E. The cost function may be computed according to the following equation:

$$E = \frac{1}{N} ( {\sum }_{k = 1}^{N} {‖ {\underline{X}}_{k} - {\underline{\hat{X}}}_{k} ‖}^{2} + {αΩ}_{KL} ( ρ \vert \vert {\hat{ρ}}_{hidden} ) ) + β ‖ W ‖$$

In the above equation, N is the total number of training samples, i.e., the total number of HRTFs. Additionally, Xₖ is the input of the encoder and \hat{X}ₖ is the output of the decoder. The goal of the training is to minimize the difference between the input and the output. The output may also be referred to as the estimated input. In this example, the cost function includes a linear weighted combination of a mean-square error term between the input and the estimated input (at the output of the decoder) and a Kullback-Liebler divergence measure between the activation functions of the hidden layers and a sparsity parameter (ρ) to keep some of the hidden neurons inactive some or most of the time. In the above equation, ρ represents the desired average output activation value of the neurons, \hat{ρ}_{hidden} represents the average output activation value of the hidden neurons, α represents the sparsity parameter, and Ω_{KL} represents the Kullback Liebler divergence measure, which describes the distance between distributions. Adding a term to the cost function that constrains the values of \hat{ρ}_{hidden} to be low encourages the autoencoder to learn a representation where each neuron in the hidden layer responds to a small number of training examples. The cost function also includes L2 regularization on the weights, W, of the autoencoder to keep them constrained in norm, where β represents the L2 weight regularization term.

Additionally, Bayesian optimization is used to identify the optimal number of encoding and decoding layers of the autoencoder as well as the size of each layer. For Bayesian optimization a validation (i.e., evaluation) set is used along with a validation error function over which the assessment of hyperparameters is done. The validation set may be approximately 25 percent of the training set (i.e., M=0.25N from above equation). The validation error may be the mean square error between the true HRTF and the reconstructed HRTF over the validation set. In some examples, Bayesian optimization is used to identify the optimal number of layers (one layer or two layer pairs), the number of nodes, N, per layer, the sparsity, α, per layer, and the L2 weight regularization, β, per layer. The number of layers, number of nodes per layer, the sparsity per layer, and L2 weight regularization per layer may be referred to as hyperparameters of the autoencoder.

The values (i.e., the weights and biases of each neuron) at the deepest encoder layer of the autoencoder are compressed values that represent a compressed model of the input HRTFs, and are shown at block 204. The decoder portion of the autoencoder, shown at block 206, is stored for later use in the process for reconstructing new HRTFs at arbitrary angles and forms a part of the HRTF reconstruction model 128 shown in FIG. 1.

The compressed values at the output of the deepest encoder layer are used for training the artificial neural network to perform in a function approximation task where the input to the artificial neural network is an angle and the training data at the output of the artificial neural network is a latent representation of the deepest layer encoder output for the corresponding HRTF.

In some examples, the artificial neural network may be a fully-connected neural network (FCNN). The input to the FCNN, during training, is the direction of the HRTF and the output is the corresponding lower-dimensional latent representation of the autoencoder obtained during separate unsupervised training of the autoencoder. As shown at block 208, the direction input may be transformed initially to binary form with the actual input values mapped to the vertices of a q-dimensional hypercube in order to normalize the input to the first hidden layer of the artificial neural network (ANN). In an example, the input space is transformed to a 9-bit binary representation for the horizontal directions (0 to 360 degrees) and 7-bit binary representation for the elevation directions (0 to 90 degrees).

In some examples, the FCNN may be trained using a gradient descent with a momentum term and an adaptive learning rate to provide an acceptable balance between convergence time and approximation error on the training data. However, other training techniques may also be used. The trained FCNN is a subspace approximation model that enables interpolated HRTFs to be reconstructed.

Additionally, Bayesian optimization is used to identify the optimal number of hidden layers of the FCNN as well as the number of nodes in each layer. For Bayesian optimization a validation (i.e., evaluation) set is used along with a validation error function over which the assessment of hyperparameters is done. The validation set may be approximately 25 percent of the training set (i.e., M=0.25N from above equation). The validation error may be the mean square error between the true HRTF and the reconstructed HRTF over the validation set. The number of hidden layers and the number of nodes in each layer may be referred to as hyperparameters of the FCNN.

The trained artificial neural network, shown at block 210, is stored for later use in the process for reconstructing new HRTFs at arbitrary angles and forms the next part of the HRTF reconstruction model 128 shown in FIG. 1. The process described above may be performed to derive separate trained artificial neural networks and decoders for each ear.

FIG. 3 is a process flow diagram showing an example process for adding directionality to sound using the HRTF reconstruction models generated as described in relation to FIG. 2. The process 300 may be performed by a user device such a gaming system, virtual reality headset, and others. The process uses the trained artificial neural network 210 and the decoder portion 206 of the autoencoder shown in FIG. 2, which are both stored to the user device. For the sake of simplicity, the following description of the process 200 only describes the processing performed for a single ear. It will be appreciated that the process will be performed separately for both the left and the right ear, using separate artificial neural networks 210 and the decoder portions 206 that have been developed for each ear individually.

The process begins by receiving a direction expressed as an azimuth and elevation angle. At block 302, the direction input is transformed to a binary form by mapping the actual input direction to the vertices of a q-dimensional hypercube. This transforms the input direction to the same binary space representation used to generate the trained artificial neural network.

Next, the binary direction information generated at block 302 is input to the trained artificial neural network 210. The output of the trained artificial neural network 210 is a set of decoder input values, \hat{r}ₗ(φⱼ, θ_{L}), corresponding to the input direction. The set of decoder input values generated by the trained artificial neural network 210 are input to the decoder portion 206 of the trained autoencoder. The output of the decoder portion 206 of the trained autoencoder is a reconstructed HRTF representing an estimate of an interpolated frequency-domain HRTF that is suitable for processing the audio signal to create the impression that the sound is emanating from the input direction information. For example, if the original HRTFs were sampled at angles of 15 degrees, interpolated HRTFs may be generated for subspace angle increments, for example, 1 degree increments.

At block 304, the interpolated frequency-domain HRTF is converted to a linear-phase finite-impulse-response (FIR) filter. In some examples, a frequency sampling approach may be used for the conversion. The linear-phase FIR filter may then be converted to a minimum-phase FIR filter. The minimum-phase FIR filter is then convolved with the original audio signal to introduce the perception of directionality. The modified audio signal may then be sent to the corresponding speaker 306 (with optional filtering and amplification). The left-ear and right-ear speakers may be in a pair of headphones or earbuds, integrated into a system with a visual display for one and/or both eyes of the user, such as a virtual reality (VR) headset and/or an augmented reality (AR) headset.

As mentioned above, the above process is performed for each ear separately. The outputs to each ear may be provided in a time synchronized manner to create the proper time difference between the left-ear audio and the right-ear audio. The direction information determines whether the sound source is to be perceived as coming from the left side of the head or the right side of the head. As used herein, the term ipsilateral refers to a sound originating from the same side of the head as the corresponding ear, and contralateral refers to a sound originating from the opposite side if the head as the corresponding ear. Thus, for the left ear, ipsilateral sounds originate from the left side of the head and contralateral sounds originate from the right side of the head. Accordingly, if the sound is contralateral, an interaural time delay may be added to the contralateral FIR as shown in block 308. Alternatively, the interaural time delay may be inserted to the convolved audio (given the linearity and commutativity of the operations in linear systems).

The time delay may be calculated based on the speed of sound and the head width. The head width may be an average head width or may be determined for the individual user. Adding the time delay separately from the saves processing resources that would be used by the HRTF reconstruction model to calculate the delay. Keeping the delay as a separate operation also allows the system to be dynamically adjusted to different sized heads, although without the frequency specific shifts which may vary with head size.

In an example, the system identifies an ear to ear separation value and uses the separation value to calculate the delay. This separation may be adjusted by a user over time via a learning and/or feedback program. This separation may also be measured by a set of headphones. For example, the headphones, earbuds, helmet, etc. may include a separation sensor. The separation sensor may be a calibrated electromagnetic and/or acoustical, including outside the human perception range, signal which is detected by a sensor on the other ear. The two ear pieces may chirp to each other to determine information about the auditory characteristics, for example, the amount of absorption and/or echoing, of the local environment. In an example, the system may detect removal of one sensor from an ear, for example, due to a change in separation over a threshold and/or change in orientation, and shift from two audio output channels to single channel audio until the second earpiece is restored.

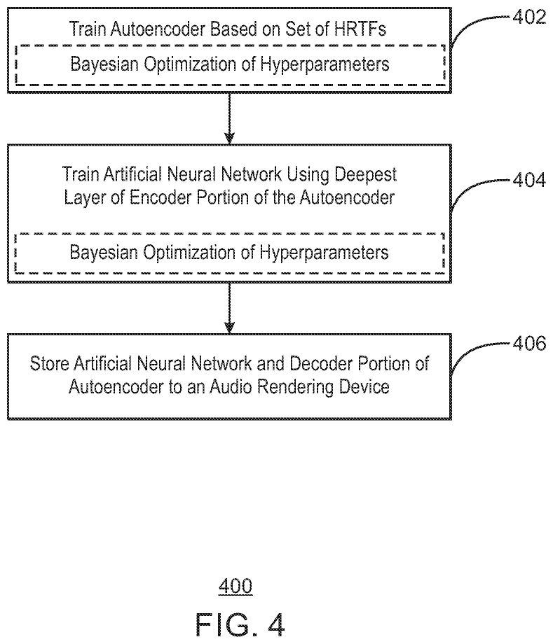

FIG. 4 is a process flow diagram summarizing a method of generating a set of HRTF reconstruction models. The method 400 may be performed by the computer system 102, and may begin at block 402.

At block 402, an autoencoder is trained using a set of HRTFs as input. The autoencoder includes an encoder portion and a decoder portion. The deepest layer of the encoder portion is a compressed representation of the original set of HRTFs input to the autoencoder. The autoencoder may be optimized using Bayesian optimization to determine a number of layers and a number of neurons per layer of the autoencoder.

At block 404, an artificial neural network is trained using the compressed representation of the original set of HRTFs obtained from the deepest layer of the encoder portion generated at block 402. The trained artificial neural network represents a subspace reconstruction model for generating interpolated HRTFs. The trained artificial neural network may be generated using Bayesian optimization to determine a number of layers and a number of neurons per layer of the trained artificial neural network. In some examples, the artificial neural network is a fully-connected neural network (FCNN).

At block 406, the trained artificial neural network and the decoder portion of the autoencoder are stored to the memory of an audio rendering device, such as a gaming system or virtual reality headset, for example. The trained artificial neural network and the decoder portion of the autoencoder may be used to reconstruct new interpolated HRTFs for specified directions. The new head related transfer function is used to process an audio signal to produce a perception of directionality.

It is to be understood that the block diagram of FIG. 4 is not intended to indicate that the method 400 is to include all of the actions shown in FIG. 4. Rather, the method 400 can include fewer or additional components not illustrated in FIG. 4. For example, it will be appreciated that the process described in FIG. 4 will be repeated for separately the left-ear and right-ear HRTF reconstruction models.

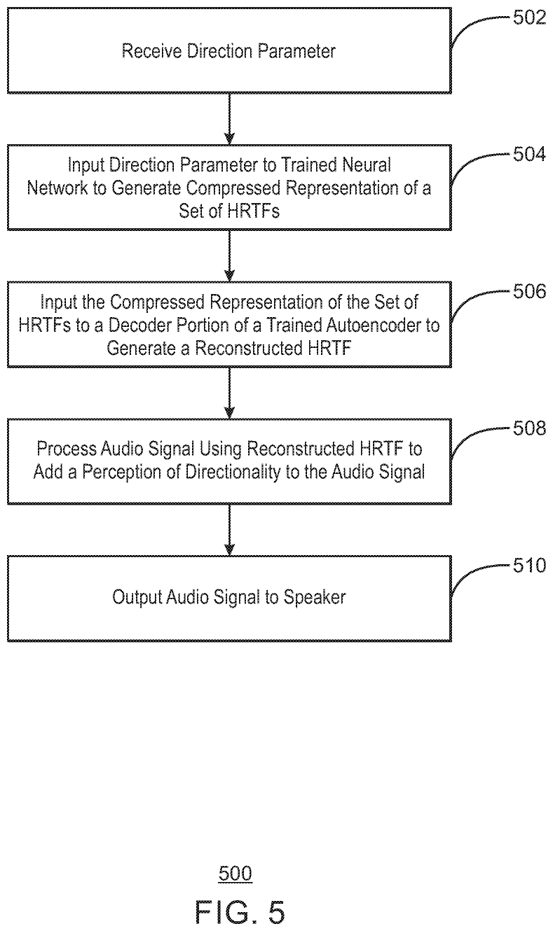

FIG. 5 is a process flow diagram summarizing a method of adding directionality to audio using the HRTF reconstruction models of FIG. 4. The method 500 may be performed by the user device 122 shown in FIG. 1, and may begin at block 502.

At block 502, a direction parameter is received. The direction parameter may be azimuth and elevation angle describing a directionality of sound included in an audio signal.

At block 504, the direction parameter is provided as input to a trained neural network, which generates a compressed representation of a set of HRTFs. In some examples, the direction parameter is first converted to a binary form as described above.

At block 506, the compressed representation of the set of HRTFs is provided as input to a decoder portion of a trained autoencoder to generate a reconstructed HRTF. The reconstructed HRTF may be an approximation of the original HRTFs used to train the autoencoder and artificial neural network, including interpolated HRTFs.

At block 508, the reconstructed HRTF is used to process the audio signal to process audio signal to add a perception of directionality to the audio signal. At block 510, the processed audio signal is sent to a speaker.

It is to be understood that the block diagram of FIG. 5 is not intended to indicate that the method 400 is to include all of the actions shown in FIG. 5. Rather, the method 400 can include fewer or additional components not illustrated in FIG. 5. For example, it will be appreciated that the process described in FIG. 5 will be repeated for both the left-ear and right-ear speaker outputs of an audio rendering device.

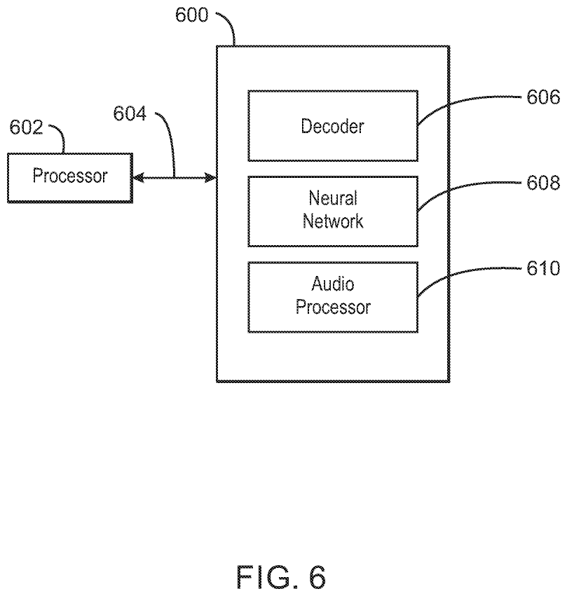

FIG. 6 is a block diagram showing a medium 600 that contains logic for rendering audio to generate a perception of directionality. The medium 600 may be a non-transitory computer-readable medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The medium 600 includes an autoencoder trained decoder 606 to compute a transfer function based on a compressed representation of the transfer function. The medium also includes a trained neural network 608 to cause the processor to select the compressed representation of the transfer function based on an input direction representing a directionality of sound included in the audio signal. The medium also includes logic instructions 610 that direct the processor 602 to process an audio signal based on the transfer function and send the modified audio signal to a first speaker.

The block diagram of FIG. 6 is not intended to indicate that the medium 600 is to include all of the components shown in FIG. 6. Further, the medium 600 may include any number of additional components not shown in FIG. 6, depending on the details of the specific implementation.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method of adding a perception of directionality to audio, comprising:
training an artificial neural network based a set of head related transfer functions (HRTFs) to generate a trained artificial neural network, wherein the trained artificial neural network represents a subspace reconstruction model for generating interpolated HRTFs, and wherein the trained artificial neural network is generated using Bayesian optimization to determine a number of layers and a number of neurons per layer of the trained artificial neural network; and
storing the trained artificial neural network, wherein the trained artificial neural network is used to reconstruct a new head related transfer function for a specified direction, and wherein the new head related transfer function is used to process an audio signal to produce a perception of directionality.

2. The method of claim 1, comprising training an autoencoder based on the HRTFs, wherein a deepest layer of an encoder portion of the autoencoder is a compressed representation of the HRTFs and is used to train the artificial neural network.

3. The method of claim 2, wherein the autoencoder is generated using Bayesian optimization to determine a number of layers and a number of neurons per layer of the autoencoder.

4. The method of claim 2, wherein to reconstruct the new head related transfer function for the specified direction, the trained artificial neural network is to receive the specified direction and generate a set of interpolated values to input into a decoder portion of the autoencoder to generate the new head related transfer function.

5. The method of claim 1, wherein the set of HRTFs are parameterized by an azimuth angle and an elevation angle, and wherein the specified direction is a specified azimuth angle and a specified elevation angle representing a directionality of the audio signal.

6. The method of claim 1, wherein the trained artificial neural network is stored to a memory device of a gaming system.

7. A system for rendering audio, comprising:
a processor; and
a memory comprising instructions to direct the actions of the processor, wherein the memory comprises:
an autoencoder trained decoder to cause the processor to compute a transfer function based on a compressed representation of the transfer function;
a neural network to cause the processor to select the compressed representation of the transfer function based on an input parameter; and
an audio player to modify an audio signal based on the transfer function and send the modified audio signal to a first speaker.

8. The system of claim 7, wherein the decoder and the neural network are optimized using Bayesian optimization to determine a number of layers and a number of neurons per layer of the decoder and the neural network.

9. The system of claim 7, wherein the input parameter is a direction representing a perceived directionality of sound included in the audio signal.

10. The system of claim 7, wherein the input parameter a specified azimuth angle and a specified elevation angle representing a perceived directionality of sound included in the audio signal.

11. The system of claim 7, wherein the instructions are to add an interaural time delay to the modified audio signal.

12. The system of claim 7, wherein the memory comprises:
a second autoencoder trained decoder to cause the processor to compute a second transfer function based on a second compressed representation of the second transfer function; and
a second neural network to cause the processor to select the second compressed representation of the second transfer function based on the input parameter;
wherein the audio player is to modify the audio signal based on the second transfer function and send the second modified audio signal to a second speaker.

13. A tangible, non-transitory, computer-readable medium comprising instructions that, when executed by a processor, direct the processor to:
receive direction information representing a perceived directionality of sound to be added to an audio signal;
input the direction information to a neural network to generate a compressed representation of a head related transfer function (HRTF);
input the compressed representation of the HRTF to an autoencoder trained decoder to generate the HRTF; and
modify an audio signal based on the HRTF and send the modified audio signal to a first speaker.

14. The computer-readable medium of claim 13, wherein the decoder and the neural network are optimized using Bayesian optimization to determine a number of layers and a number of neurons per layer of the decoder and the neural network.

15. The computer-readable medium of claim 13, wherein the direction information is a specified azimuth angle and a specified elevation angle.
